(19) United States
(12) Patent Application Publication
(10) Pub. No.: US 2023/0311933 A1
(43) Pub. Date: Oct. 5, 2023

(54) DEVICE FOR GENERATING A MOVEMENT LIMITATION SIGNAL FOR AN AUTONOMOUS MOTOR VEHICLE, ASSOCIATED CONTROL SYSTEM, ASSEMBLY AND METHOD

(71) Applicant: TRANSDEV GROUP INNOVATION, ISSY-LES-MOULINEAUX (FR)

(72) Inventors: Paulo MIRANDA, VOISINS LE BRETONNEUX (FR); Nicolas DESMOINEAUX, COURBEVOIE (FR); Laurent VALLOT, CHARTRES (FR); Jean Michel TAINHA, VERSAILLES (FR)

(21) Appl. No.: 17/743,186

(22) Filed: May 12, 2022

(30) Foreign Application Priority Data
Mar. 31, 2022 (FR) 22 02948

(51) Int. Cl. B60W 60/00; H04W 4/44; B60W 50/00

(52) U.S. Cl. CPC B60W 60/001; H04W 4/44; B60W 50/0098; B60W 2556/45; B60W 2050/0019

(57) ABSTRACT

A device for generating a movement limitation signal for an autonomous motor vehicle equipped with an autopilot device adapted to pilot the autonomous vehicle, the autonomous vehicle belonging to a fleet of autonomous vehicles whose movements are supervised by a control center, via a communication network, the generation device being intended to be carried onboard the autonomous motor vehicle, the generation device operating by successive iterations, and the generation device including: —a key generator, adapted to generate a specific key; and —a communication unit, configured to transmit a first signal and to receive a response signal.

### CROSS-REFERENCE TO RELATED APPLICATIONS

This application claims priority to French Patent Application No. 22 02948 filed Mar. 31, 2022, the entire contents of which are hereby incorporated by reference.

### BACKGROUND OF THE INVENTION

### Field of the Invention

The present invention relates to a device for generating a movement limitation signal for an autonomous motor vehicle.

The invention further relates to a generation method.

The present invention relates to the field of control of autonomous motor vehicles and to the field of remote control of a fleet of autonomous motor vehicles, in particular.

### Description of the Related Art

“Autonomous motor vehicle” means a vehicle adapted to move along a trajectory without a human driver intervening either on board the vehicle or at a distance. Such a vehicle includes an autopiloting device that makes it possible to move the vehicle along a trajectory.

Monitoring the different vehicles of a fleet of autonomous vehicles from a fleet control center, connected with each vehicle in the fleet through an adapted communication network, is known.

In case of detection of a problem affecting a vehicle, the control center must be able to command the vehicle to stop by transmitting an adapted instruction to stop.

However, if the communication network fails, for example, no instruction to stop can be transmitted to the vehicle. In the event of a problem, the control center loses the ability to stop the vehicle.

It is therefore necessary to guarantee the ability to transmit such an instruction at all times, and the ability of the receiving vehicle to take this into account, in order to be certain of being able to effectively order any vehicle in the fleet to stop, if necessary.

High requirements are defined then, regarding the transmission reliability of the communication network, as well as the processing reliability by each autonomous vehicle of an instruction to stop.

However, the implementation of such requirements is relatively complex and tedious.

### SUMMARY OF THE INVENTION

An objective of the present invention is thus to guarantee the control of an autonomous vehicle of a fleet of vehicles, in particular a control over the vehicle stopping, by means that are simpler to implement, while being particularly reliable.

To this end, a subject-matter of the invention is a device for generating a movement limitation signal for an autonomous motor vehicle equipped with an autopilot device adapted to pilot the autonomous vehicle, the autonomous vehicle belonging to a fleet of autonomous vehicles whose movements are supervised by a control center, via a communication network, the generation device being intended to be embedded onboard the autonomous motor vehicle, the generation device operating by successive iterations, and the generation device comprising:
a key generation means, adapted to generate a key specific to a current iteration of the generation device operation;
a communication unit, configured to:
transmit a first signal, intended for the control center, via the communication network, the first signal comprising the key specific to the current iteration;
receive a second signal in response to the first signal from the control center, during the current iteration, called response signal, via said communication network, the response signal comprising a transformed key resulting from the transformation of the key specific to the current iteration according to a predetermined transfer function;
a calculation unit, configured to calculate a third signal, called expected signal, comprising an expected key resulting from the transformation of the key specific to the current iteration according to the predetermined transfer function;
a comparison unit, configured to compare the response signal and the expected signal at the current iteration to obtain an intermediate result, and to generate a comparison result from the intermediate result; and
a generation unit, configured to generate a first message, from the comparison result, to incorporate the first message into the movement limitation signal for the current iteration, and to input the generated movement limitation signal to the autopilot device,

when the expected signal is the same as the response signal, the movement limitation signal generated does not constrain the autopilot device in driving the autonomous vehicle, and when the expected signal is different from the response signal, the movement limitation signal generated constrains the autopilot device in piloting the autonomous vehicle.

According to further advantageous aspects of the invention, the generation device comprises one or more of the following features, taken alone or in any technically possible combination:
the comparison unit comprises a first calculation module configured to determine a first component of the comparison result, at least by applying a first comparison function to the response signal and the expected signal; a second calculation module configured to determine a second component of the comparison result, at least by applying a second comparison function to the response signal and the expected signal, wherein the second comparison function is different from the first comparison function and wherein the generation unit generates the first message of the movement limitation signal from the first and second components of the comparison result;
the first calculation module is configured to assign a primary fixed value relating to a movement prohibition to the first component, in the absence of the receiving the response signal, and the second calculation module is configured to assign a secondary fixed value relating to a movement prohibition to the second component, in the absence of the reception of the response signal, when the first component has the primary fixed value and the second component has the secondary fixed value, wherein the generated movement limitation signal constrains the autopilot device in piloting the autonomous vehicle;
the movement limitation signal further comprises a second message resulting from the concatenation of a first counter incremented during the application of the first comparison function by the first calculation module, and of a second counter incremented during the application of the second comparison function by the second calculation module;
the movement limitation signal also comprises a third message corresponding to a checksum determined from the first message and possibly from the second message;
the first message of the movement limitation signal takes values from a predetermined list of possible values containing:
a first value, indicating an authorization of the continuation of the current movement;
a second value, indicating a prohibition of the continuation of the current movement;
a third value, indicating an initialization of the generation device; and
a fourth value, indicating an invalid limitation signal;
the key generation means is a key generator configured to generate the key specific to the current iteration by means of the execution of a pseudo-random algorithm.

Another subject-matter of the invention is an autonomous vehicle control system to be carried in the autonomous vehicle, the control system comprising a generation device, as described above, as well as an autonomous vehicle autopilot device configured to pilot the autonomous vehicle according to the movement limitation signal.

According to another advantageous aspect of the invention, the control system comprises one or more of the following features, taken alone or in any technically possible combination:
the autopilot device is configured to control the stopping of the autonomous vehicle upon receipt of a binding movement limitation signal during a predetermined number of consecutive iterations of the control system, upon receipt of an invalid movement limitation signal during a predetermined number of consecutive iterations of the control system, and/or in the absence of the receipt of a movement limitation signal during a predetermined number of consecutive iterations of the control system.

It is a further subject-matter of the invention to provide an assembly comprising a control system as described above, and further comprising a control center of a fleet of autonomous vehicles, the control center comprising at least one determination device configured to determine the response signal by applying the predetermined transfer function on the first signal, and to transmit the response signal to the generation device via the communication network.

The invention further relates to a generation method implemented by a generation device as described above, comprising, for a current iteration, the following steps:
generating a key specific to the current iteration;
elaborating and transmitting a first signal comprising the specific key to the control center via the communication network
receiving a response signal from the control center via the communication network, the response signal including a transformed key resulting from the application of a transformation predefined by the control center on the specific key
elaborating and generating an expected signal comprising an expected key resulting from the application of the transformation predefined by the generation device on the specific key
comparing the response signal and the expected signal to obtain an intermediate result, and generating a comparison result from the intermediate result; and
generating a limitation signal from the comparison result, the movement limitation signal being applied to an input of the autopilot device, to constrain the piloting of the autonomous vehicle.

The invention further relates to a non-transitory computer-readable medium including a computer program comprising software instructions that implement a generation method as described above, when executed by an onboard computer embedded in an autonomous vehicle.

### BRIEF DESCRIPTION OF THE DRAWINGS

The features of the invention will become clearer upon reading the following description, given only as an illustrative and non-limiting example, this description being made with reference to the appended drawings, in which:

FIG. 1 is a schematic representation of an embodiment of an assembly comprising a remote control center and an onboard control system in a vehicle and comprising a device for generating a limitation signal; and,

FIG. 2 is a flow chart of an embodiment of a method of generating a limitation signal.

### DESCRIPTION OF THE PREFERRED EMBODIMENTS

Generally, the invention consists of an onboard computer (referred to in the following as a generation device) placed as an interface between an automatic piloting device of the autonomous vehicle, and a remote control center of the autonomous vehicle.

While the function of the piloting device is to pilot the vehicle so that it follows this or that trajectory, the function of the control center is to supervise the movements of all the autonomous vehicles of a fleet of vehicles.

The onboard computer then makes it possible to guarantee that the movement of the vehicle it equips is effectively supervised by the control center.

The onboard computer regularly transmits a movement limitation signal to the control device, the value of which indicates the situation and is suitable for constraining the control device.

In nominal operation, the limitation signal authorizes the autonomous vehicle to continue moving. In faulty operation, the limitation signal forces the control device to place the vehicle in a safe position, by making the vehicle return at a reduced speed to the nearest station and stop at this station to make it possible for the passengers of the vehicle to get off, for example, or by ordering an immediate stop of the vehicle, for example.

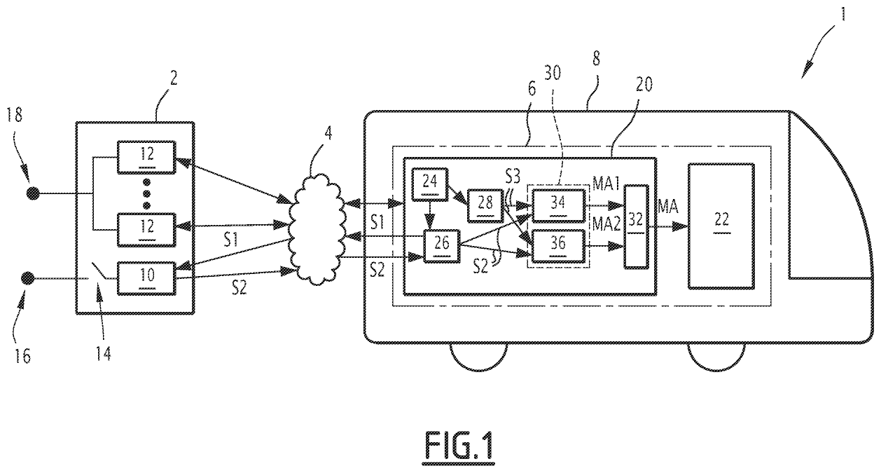

FIG. 1 represents an embodiment of an assembly 1 comprising a control center 2, a communication network 4 and a control system 6, which is carried onboard an autonomous vehicle 8 belonging to a fleet of autonomous vehicles controlled by the control center 2. The control system 6 comprises a generation device 20 and an autopilot device 22 of the vehicle 8.

The autopilot device 22 is adapted to pilot the autonomous vehicle 8 to conduct a predetermined mission.

The generation device 20 is adapted to generate a movement limitation signal MA and apply it to the autopilot device 22 so as to constrain the operation of the autopilot device 22 in case of loss of the supervisory link with the control center 2.

The generation device 20 is adapted to communicate with the control center 2 via the network 4.

The generation device 20 operates cyclically (or iteratively) so as to regularly update the value of the movement limitation signal MA based on the current state of communication with the control center 2.

The control center 2 comprises a determination device 10. The device 10 is configured to receive a first signal S1 from the generation device 20, comprising a key specific to a current iteration of the operation of the generation device 20.

The device 10 is adapted to apply a predetermined transfer function to the specific key, to obtain a transformed key. The device 10 is adapted to generate a second signal, referred to as a response signal S2 containing the transformed key. The device 10 is configured to transmit the response signal S2 to the control system 6, via the communication network 4.

Advantageously, the control center 2 comprises at least one communication device 12 for communication with the autonomous vehicles in the fleet. Preferably, the control center 2 comprises several communication devices 12. The or each communication device 12 is configured to transmit audio or visual announcements to passengers of the autonomous vehicle 8 and/or obtain data measured by sensors equipping the autonomous vehicle 8, for example, such as video images of the interior of the autonomous vehicle 8.

More advantageously, the control center 2 comprises a switch 14, configured to cut off a power supply 16 of the determination device 10 in order to interrupt operation of the determination device 10 and prevent it from generating and transmitting the response signal S2.

Preferably, the or each communication device 12 is configured to be powered by a power supply 18 separate from the power supply 16 of the determination device 10. This makes it possible for an operator to continue to be able to communicate with the autonomous vehicle 8 by using the communication device 12, even when the power supply 16 of the determination device 10 is turned off by the switch 14, for example.

The communication network 4 is a wireless network that implements a predetermined communication protocol, for example.

The generation device 20 comprises a key generator 24, a communication unit 26, a calculation unit 28, a comparison unit 30 and a generation unit 32.

In the embodiment shown in FIG. 1, the generation device 20 is a computer and the key generator 24, the communication unit 26, the calculation unit 28, the comparison unit 30 and the generation unit 32 are each implemented at least partially as software, or a software brick stored in a memory of the device 20 and executable by a processor of the device 20, for example.

The key generator 24 is configured to generate a current key by executing a pseudo-random algorithm. The current key is specific to an iteration of the operation of the generation device 20. In other words, at each cycle of operation of the generation device 20, the pseudo-random algorithm is executed to determine a new key, which is as a result specific to that cycle (to that iteration) of operation of the device 20.

In one variant, other means of generating keys may be envisaged, such as a database comprising a predefined list of keys. At each iteration of operation of the generation device 20, the next key in the list is selected as the current key.

The communication unit 26 is configured to generate the first signal S1, incorporating the current iteration specific key therein. The communication unit 26 is configured to transmit the first signal S1 to the control center 2 via the communication network 4.

The communication unit 26 is further configured to wait for a response from the control center 2 for a predetermined time interval, after transmitting the first signal S1.

The communication unit 26 is adapted to receive the response signal S2 associated with the first signal S1 from the control center 2 via the communication network 4, and to apply this response signal S2 as an input to the comparison unit 30.

The calculation unit 28 is configured to calculate an expected key by applying the predetermined transfer function to the current iteration specific key. The transfer function is identical to the one used by the control center 2. The calculation unit 28 generates a third signal, called the expected signal S3, incorporating the expected key and applies the third signal as an input to the comparison unit 30.

The comparison unit 30 is configured to compare the keys of the response signal S2 and the expected signal S3 of the current iteration to obtain an intermediate result, and to generate a comparison result from the intermediate result.

In the embodiment contemplated here, the comparison result contains first and second components MA1, MA2, obtained from respective parts of the intermediate result.

To do so, the comparison unit 30 comprises a first calculation module 34, which is configured to determine the first component MA1. In particular, the first calculation module 34 is configured to apply a first comparison function, dependent on both the response signal S2 and the expected signal S3, to obtain a first part of the intermediate result, and to transform this first part into the first component MA1 of the comparison result.

The comparison unit 30 comprises a second calculation module 36, which is configured to determine the second component MA2. In particular, the second calculation module 36 is configured to apply a second comparison function, dependent on both the response signal S2 and the expected signal S3, to obtain a second part of the intermediate result, and to transform this second part into the second component MA2 of the comparison result.

The second comparison function is different from the first comparison function.

The generation unit 32 is configured to generate the movement limitation signal MA based on the comparison result, in this case the first and second components MA1, MA2.

For example, the generation unit 32 incorporates a first message into the limitation signal from a plurality of possible values, the value of which is obtained from the values MA1 and MA2.

These possible values of the first message are 8-bit encoded, for example.

These possible values belong to a predefined list:
0x6A, indicating an authorization to continue the current movement;
0x95, indicating a prohibition on continuing the current movement;
0x00, indicating initialization of the generation device;
0xFF, indicating an invalid limitation signal (such as in the event of a failure of the generation device).

Any other value of the first message contained in the limitation signal MA will be considered invalid by the autopilot device 22.

Advantageously, these values are obtained by concatenating the values of the first and second components MA1 and MA2, in particular bit-encoded.

For example, when the first component MA1 is equal to 0x60, and the second component MA2 is equal to 0x0A, the generation module 32 obtains the value 0x6A for the first message.

For example, when MA1=0x90 and MA2=0x05, the generation module 32 obtains the value 0x95 for the first message.

Finally, for example, when MA1=0xF0 and MA2=0x0F, the generation module 32 obtains the value 0xFF for the first message.

Advantageously, in addition to this first message, the limitation signal MA comprises a second message, advantageously 8-bit encoded, resulting from the concatenation of two counters, with the first counter indicating the execution of the first calculation module 34 and the second counter indicating the execution of the second calculation module 36.

More advantageously, in addition to this first message and/or this second message, the limitation signal MA comprises a third message corresponding to a checksum.

The generation unit 32 applies the movement limitation signal MA to the autopilot device 22. The latter is adapted to take the limitation signal into account in controlling the vehicle, in particular to continue or to interrupt the current movement.

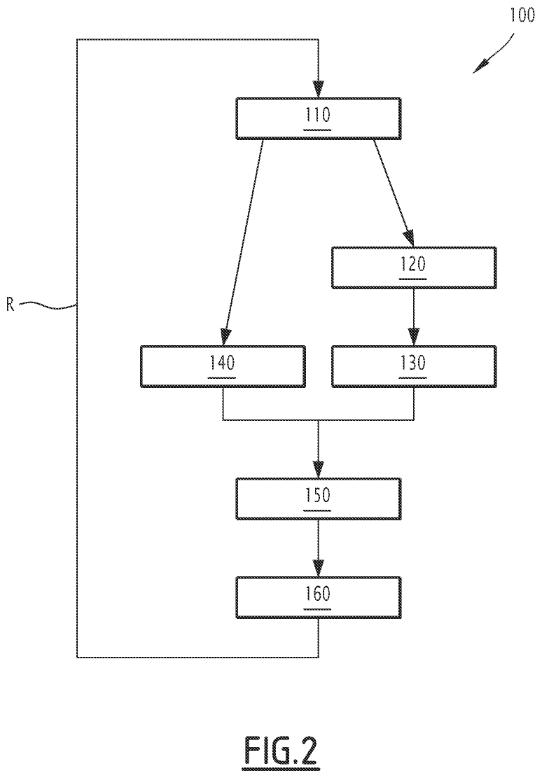

One embodiment of the determination method 100 of the movement limitation signal MA will now be described with reference to FIG. 2.

The determination method 100 is implemented by the generation device 20.

The determination method 100 is implemented by iteration (or cycle). A given iteration of the method 100 comprises a generation step 110, an elaboration and transmission step 120, a receipt step 130, an elaboration and generation step 140, a comparison step 150, and a generation step 160.

Preferably, after execution of the iteration, the method 100 is repeated, as illustrated by arrow R in FIG. 2.

In the generation step 110, the key generator 24 generates the iteration-specific key according to a pseudo-random algorithm.

In an elaboration and transmission step 120, the communication unit 26 generates and transmits the first signal S1, including the iteration-specific key, to the control center 2 via the communication network 4.

In the receipt step 130, the communication unit 26 receives the response signal S2, from the control center 2, via the communication network 4, in response to the first signal S1.

In the elaboration and generation step 140, the calculation unit 28 elaborates and generates the expected signal S3, by applying the predetermined transfer function on the first signal S1 including the iteration-specific key.

Steps 130 and 140 are preferably implemented simultaneously.

In particular, the comparison step 150 is only implemented as a continuation of the implementation of steps 130 and 140.

In the comparison step 150, the comparison unit 30 receives the response signal S2 from the communication unit 26 and the expected signal S3 from the calculation unit 28.

The comparison unit 30 compares the response signal S2 with the expected signal S3 to obtain an intermediate result, and constructs a comparison result from the intermediate result. The comparison result consists of the components MA1 and MA2 in particular. The comparison unit 30 preferably transmits the components MA1 and MA2 to the generation unit 32.

In the generation step 160, the generation unit 32 generates the movement limitation signal MA from the comparison result, in particular based on the components MA1, MA2.

The generation unit 32 applies the movement limitation signal MA to an input of the autopilot device 22.

The way the device 22 pilots the autonomous vehicle 8 is constrained by the value of the movement limitation signal MA.

When the expected signal S3 is the same as the response signal S2, the movement limitation signal MA generated does not constrain the autopilot device 22 in driving the autonomous vehicle 8.

When the expected signal S3 is different from the response signal S2, the movement limitation signal MA generated constrains the autopilot device 22 in piloting the autonomous vehicle 8.

In the absence of the generation device receiving the response signal S2, the movement limitation signal MA generated constrains the autopilot device 22 in piloting the autonomous vehicle 8.

In particular, when the first component MA1 has a primary fixed value relating to a prohibition of movement and the second component MA2 has a secondary fixed value relating to a prohibition of movement, the movement limitation signal MA generated constrains the device 22 in piloting the vehicle 8.

The operation of the assembly 1 shall now be described for different situations or cases of use.

The generation device 20 operates by iterations. During each iteration, the first signal S1, the response signal S2, the expected signal S3 and the movement limitation signal MA are determined. The signals S1, S2 and S3 are a priori different, from one iteration to the next, to guarantee identification of a loss of exchanges with the control center 2. In the following, the operation of the assembly 1 is described for an iteration called the current iteration.

Case of an Authorization to Move the Autonomous Vehicle 8

In this case of use, the assembly 1 operates in a nominal mode and the movement limitation signal MA applied to the autopilot device 22 indicates an authorization to move.

In the nominal mode, the generation device 20 shows no failure and the determination device 10 is powered by the power supply 16, with the switch 14 closed.

The key generator 24 generates the specific key for the current iteration and transmits it to the communication unit 26 and the calculation unit 28.

The communication unit 26 constructs and transmits the first signal S1 containing the specific key to the determination device 10 of the control center 2, via the communication network 4.

The determination device 10 determines the transformed key from the specific key received in the first signal. It generates the response signal S2 containing the transformed key and transmits the response signal S2, via the communication network 4, to the communication unit 26 as a response to the first signal S1.

The transfer function used is equal to f(x)=1.5x+1, for example, where x is the specific key. If the value of the specific key is equal to 2, for example, then the transformed key has a value equal to 4.

In one example, the specific key is formed by 64-bit unsigned integers (also called UINT64).

Also in the current iteration, the calculation unit 28 calculates an expected key by applying the same predetermined transfer function to the specific key. According to the numerical example above, the computation unit 28 determines that the expected key is 4. The unit 28 generates an expected signal S3 that incorporates this expected key.

The first module 34 and the second module 36 each receive the response signal S2 and the expected signal S3.

The first comparison function used by the first calculation module 34 to determine the first part of the intermediate result is the difference between the response signal and the expected signal, for example. Thus, in the above numerical example, the first part of the intermediate result takes the value of zero, with S2 and S3 being identical.

The first calculation module 34 then transforms this first part into the first component MA1 of the comparison result, using a predetermined mapping table for each comparison function, for example. The mapping table for the first comparison function indicates that the value “0” of the first part of the intermediate result corresponds to the value “0x60” of MA1, for example.

The second comparison function used by the second calculation module 36 to determine the second part of the intermediate result is a logic function, for example, taking the value of zero when signals S2 and S3 are different and unit value when the signals S2 and S3 are the same. Thus, in the above numerical example, the second part of the intermediate result takes the unit value, with S2 and S3 being identical.

The second calculation module 36 then transforms this second part into the second component MA2 of the comparison result, using for example the predetermined mapping table for the second comparison function. This table indicates, for example, that the unit value of the second part of the intermediate result corresponds to the value “0x0A” of MA2.

Finally, the unit 32 generates the movement limitation signal MA from the first and second components MA1 and MA2.

For example, the unit 32 concatenates the values of the components MA1, MA2, particularly expressed in bits, to obtain a concatenated value forming the first message of the signal MA. In the above numerical example, the concatenated value is then “0x6A”, which corresponds to an “authorization to move”.

According to another example, the unit 32 uses a predetermined transfer other than a concatenation to obtain the movement limitation signal MA from the first component MA1 and the second component MA2, such as a function forming the sum of the first component MA1 and the second component MA2.

Upon receiving this signal, the autopilot device 22 orders the start or continuation of the movement of the autonomous vehicle 8 along the current trajectory.

Case of a Prohibition of Movement of the Autonomous Vehicle 8

In the following, only the differences between the present case of use and the above case of use are highlighted.

In this use case, while the generation device 20 is operating in the nominal mode, the movement limitation signal MA generated corresponds to a prohibition of movement because the second signal S2 is not received from the control center 2, due to the of the power supply 16 of the determination device 10 being cut (by opening the switch 14), for example.

Under these conditions, following the transmission of the first signal S1 to the control center 2, the communication unit 26 waits in vain for receipt of the corresponding response signal S2.

In this case, the communication unit 26 does not transmit any signal to the first and second modules 34, 36.

After a predetermined waiting time, in the absence of receipt of the response signal S2 by the modules 34 and 36, the first module 34 assigns a primary fixed value relating to a prohibition to the first component MA1, such as 0x90, and the second calculation module 36 assigns a secondary fixed value relating to a prohibition to the second component MA2, such as 0x05.

In particular, it is not possible for the modules 34, 36 to apply the first and second comparison function in the absence of receipt of the signal S2, because this signal S2 is an argument of the first and second comparison function, required for the application of the respective function.

The values of the first component MA1 and the second component MA2, in this case MA1=0x90 and MA2=0x05, are transmitted to the unit 32, which generates the adapted movement limitation signal MA, in this case MA=0x95.

The primary fixed value and the secondary fixed value are thus predetermined values so as to obtain the movement limitation signal MA, indicating a prohibition of movement of the autonomous vehicle 8.

For example, the unit 32 generates the first message of the movement limitation signal MA in the same way as in the case of authorizing movement, by concatenating the values of the first component MA1 and the second component MA2, for example.

In this case, the value of the first message obtained is indicating a prohibition of movement of the autonomous vehicle 8 (0x95).

Upon receiving this value, the autopilot device 22 orders the autonomous vehicle 8 to stop. A stop may be the immediate stopping of the vehicle or, preferably, consists of safely piloting the vehicle 8 to the nearest station.

Preferably, the receipt of a limitation signal MA, indicating a stop during a single iteration, is sufficient to initiate the stop. This makes it possible to order the stop quickly. In a variant, the device 22 waits to receive a limitation signal indicating a stop during several successive iterations to initiate the shutdown.

Case of a Failure Affecting the Generation Device 20

In this case of use, the generation device 20 operates in a degraded mode following detection of a failure affecting it.

For example, the first calculation module 34 generates the value MA1=0x0F and the second calculation module 36 generates the value MA2=0xF0.

The generation unit 32 then outputs a movement limitation signal MA, the first message of which (0xFF) indicates an invalid signal.

The generation unit 32 obtains the first message of the movement limitation signal MA preferably by concatenating the components MA1, MA2.

When the autopilot device 22 receives this invalid signal, the autopilot device 22 orders the autonomous vehicle 8 to stop, at the next station, for example.

The stop is ordered after one or more consecutive iteration(s) with an invalid signal.

Case of a Failure of the First 34 and/or Second 36 Calculation Module

According to this use case, the generation device 20 operates in nominal mode, but a failure of the first and/or second computation module is detected.

The first calculation module 34 increments a first counter upon application of the first comparison function, and transmits a value of this first counter to the generation unit 32.

The second calculation module 36 increments a second counter when the second comparison function is applied, and transmits a value of this second counter to the generation unit 32.

Each counter has a 4-bit size, for example.

The generation unit 32 concatenates the values of the first counter and the second counter into a second message.

The second message is incorporated into the movement limitation signal MA and is transmitted to the device 22.

The device 22 is adapted to compare the value of the first counter with that of the second counter, and orders the stopping of the vehicle 8 at the next station if their values are different.

In a variant, the device 22 controls the immediate stop of the vehicle 8 if their values are different.

Preferably, the stop is ordered only after a predetermined number of consecutive iterations leading to a difference between the two counters.

This makes it possible for the device 22 to detect whether one of the modules 34 and 36 does not apply the comparison function. Indeed, in this case, the corresponding counter is not incremented.

Case of the Automatic Control Device 22 not Receiving the Movement Limitation Signal MA

In this case of use, the autopilot device 22 does not receive any limitation message.

When the autopilot device 22 determines the absence of a receipt of the movement limitation signal MA during a predetermined number of consecutive iterations, the autopilot device 22 orders the autonomous vehicle 8 to stop.

The predetermined number of iterations is preferably greater than or equal to 2. In particular, this makes it possible to avoid ordering the stop when the MA signal is not transmitted during a single iteration.

Case of Failure of Transmission of the Movement Limitation Signal MA to the Autopilot Device 22

In this use case, there is a failure in the connection between the generation device and the autopilot device 22.

The generation unit 32 determines a checksum from the first message and optionally from the second message.

The generation unit 32 adds the checksum to the movement limitation signal MA before transmitting it to the device 22.

Upon receipt of the limitation signal, the device 22 determines a checksum, called the expected checksum, from the first message and optionally the second message, in the same manner as the generation unit 32. The device 22 compares the checksum included in the AM signal and the expected checksum.

When the device 22 determines a difference, preferably during a predetermined number of consecutive iterations, the autopilot device 22 orders the autonomous vehicle 8 to stop.

The predetermined number of iterations is preferably greater than or equal to 2. In particular, makes it possible to avoid ordering the stop in case of an MA signal transmission failure during a single iteration.

Variations and Advantages

It is conceivable that the generation device 20 and the determination method 100 according to the invention have a large number of advantages.

The generation device 20 makes it possible to constrained the piloting of an autonomous vehicle 8 based on the state of the connection with the control center 2, since the onboard generation device 20 determines the movement limitation signal MA based on the received response signal S2.

In the event of a failure of the communication network 4 involving an interruption of communication between the control center 2 and the autonomous vehicle 8, the latter is stopped at the next station, for example.

In particular, thanks to the generation device 20, it is possible to achieve communication between the generation device 20 and the control center 2 through a standard communication network, in particular a network without any high requirements regarding its reliability, without compromising the safety of the vehicle 8.

The generation device 20 ensures that an interruption (such as a power supply failure) or malfunction (inability to calculate the result of the specific key transformation) of the determination device 10 is taken into account for making the autonomous vehicle 8 safe for piloting.

Indeed, whatever the reason for the absence of reception of the signal S2 (interruption of the device 10, failure of the network 4, etc.), the generation device 20 detects this absence to order the vehicle to stop.

Advantageously, in the event of a calculation error by the generation device 20 or a failure in the transmission of the signal MA between the device 20 and the device 22, the device 22 orders the vehicle 8 to stop.

In particular, the generation device 20 makes it possible at least to limit or even avoiding the erroneous sending of the movement limitation signal MA indicating an authorization of further movement of the vehicle, even when using standard type hardware and software components.

1. A device for generating a movement limitation signal for an autonomous motor vehicle equipped with an autopilot device adapted to pilot the autonomous vehicle, the autonomous vehicle belonging to a fleet of autonomous vehicles whose movements are supervised by a control center via a communication network, the generation device being intended to be embedded on board the autonomous motor vehicle, the generation device operating by successive iterations, and the generation device comprising:
a key generation means, adapted to generate a key specific to a current iteration of the generation device operation;
a communication unit, configured to:
transmit a first signal to the control center via the communication network, the first signal comprising the key specific to the current iteration;
receiving a second signal from the control center via said communication network during the current iteration, called response signal, in response to the first signal, the response signal comprising a transformed key resulting from the transformation of the key specific to the current iteration according to a predetermined transfer function;
a calculation unit, configured to calculate a third signal, called expected signal, comprising an expected key resulting from the transformation of the key specific to the current iteration according to the predetermined transfer function;
a comparison unit, configured to compare the response signal and the expected signal at the current iteration to obtain an intermediate result, and to generate a comparison result from the intermediate result; and
a generation unit, configured to generate a first message from the comparison result, to incorporate the first message into the movement limitation signal for the current iteration, and to input the generated movement limitation signal to the autopilot device,
wherein, when the expected signal is identical to the response signal, the generated movement limitation signal does not constrain the autopilot device in piloting the autonomous vehicle, and wherein, when the expected signal is different from the response signal, the generated movement limitation signal constrains the autopilot device in piloting the autonomous vehicle.

2. The generation device according to claim 1, wherein the comparison unit comprises:
a first calculation module, configured to determine a first component of the comparison result, at least by applying a first comparison function on the response signal and the expected signal;
a second calculation module, configured to determine a second component of the comparison result, at least by applying a second comparison function to the response signal and the expected signal,
the second comparison function being different from the first comparison function, and the generation unit generating the first message of the movement limitation signal from the first and second components of the comparison result.

3. The generation device according to claim 2, wherein the first calculation module is configured to assign a primary fixed value relating to a prohibition of movement to the first component in the absence of receipt of the response signal, and the second calculation module is configured to assign a secondary fixed value relating to a prohibition of movement to the second component in the absence of receipt of the response signal,
when the first component has the primary fixed value and the second component has the secondary fixed value, the generated movement limitation signal constrains the autopilot device in driving the autonomous vehicle.

4. The generation device according to claim 2, wherein the movement limitation signal further comprises a second message resulting from the concatenation of a first counter incremented upon application of the first comparison function by the first calculation module, and of a second counter incremented upon application of the second comparison function by the second calculation module.

5. The generation device according to claim 1, wherein the movement limitation signal further comprises a third message corresponding to a checksum determined from the first message.

6. The generation device according to claim 1, wherein the first message of the movement limitation signal takes values from a predetermined list of possible values comprising:
a first value, indicating an authorization of the continuation of the current movement;
a second value, indicating a prohibition of the continuation of the current movement;
a third value, indicating an initialization of the generation device; and
a fourth value, indicating an invalid limitation signal.

7. The generation device according to claim 1, wherein the key generating means is a key generator configured to generate the key specific to the current iteration by means of the execution of a pseudo-random algorithm.

8. A control system of an autonomous vehicle to be carried in the autonomous vehicle, the control system comprising a generation device according to claim 1, as well as an autopilot device of the autonomous vehicle configured to pilot the autonomous vehicle based on the movement limitation signal.

9. The control system according to claim 8, wherein the autopilot device is configured to control the stopping of the autonomous vehicle upon receipt of a constraining movement limitation signal during a predetermined number of consecutive iterations of the control system, upon receipt of an invalid movement limitation signal for a predetermined number of consecutive iterations of the control system, and/or upon failure to receive a movement limitation signal for a predetermined number of consecutive iterations of the control system.

10. An assembly comprising a control system according to claim 8, and further comprising a control center of a fleet of autonomous vehicles, the control center comprising at least one determination device configured to determine the response signal by applying the predetermined transfer function to the first signal, and to transmit the response signal to the generation device via the communication network.

11. A generation method implemented by a generation device according to claim 1, comprising the following steps for a current iteration:
generating a key specific to current iteration;
elaborating and transmitting a first signal comprising the specific key to the control center via the communication network;
receiving a response signal from the control center, via the communication network, the response signal comprising a transformed key resulting from the application of a transformation predefined by the control center on the specific key;
elaborating and generating an expected signal comprising an expected key resulting from the application of the transformation predefined by the generation device on the specific key,
comparing the response signal and the expected signal to obtain an intermediate result, and developing a comparison result from the intermediate result; and
generating a limitation signal from the comparison result, the movement limitation signal being applied to an input of the autopilot device to constrain the piloting of the autonomous vehicle.

12. Non-transitory computer-readable medium including a computer program comprising software instructions that implement a generation method according to claim 11 when executed by an onboard computer embedded in an autonomous vehicle.

13. The generation device of claim 5, wherein the third message corresponding to a checksum determined from both the first message and the second message.
